(19) United States
(12) Patent Application Publication
(10) Pub. No.: US 2011/0136930 A1
(43) Pub. Date: Jun. 9, 2011

(54) METHOD FOR PREPARING VISCOELASTIC POLYURETHANE FOAM

(75) Inventors: Denise R. Butler, Clute, TX (US); Bernard E. Obi, Pearland, TX (US); Rogelio R. Gamboa, Brazoria, TX (US); Robert E. O'Neill, Clute, TX (US)

(73) Assignee: Dow Global Technologies LLC (Formerly Known as Dow Global Technologies Inc.), Midland, MI (US)

(21) Appl. No.: 13/025,732

(22) Filed: Feb. 11, 2011

Related U.S. Application Data
(62) Division of application No. 12/307,988, filed on Jan. 8, 2009, now abandoned.
(60) Provisional application No. 60/836,810, filed on Aug. 10, 2006.

(51) Int. Cl. C08J 9/35; C08K 5/098; C08K 5/19; C09K 3/00

(52) U.S. Cl. 521/118; 521/125; 252/182.28

(57) ABSTRACT

Viscoelastic polyurethane foam is prepared by using certain additives in the foam formulation. The additives include 1) alkali metal or transition metal salts of carboxylic acids; 2) 1,3,5-tris alkyl- or 1,3,5-tris (N,N-dialkyl amino alkyl)-hexahydro-s-triazine compounds; and 3) C₁₋₁₂ carboxylate salts of quaternary ammonium compounds. The additives significantly improve processing and in particular permit the use of higher isocyanate indices, which helps to improve foam physical properties.

The present application is a divisional application of the U.S. application Ser. No. 12/307,988, filed on 8 Jan., 2009, entitled “METHOD FOR PREPARING VISCOELASTIC POLYURETHANE FOAM,” the teachings of which are incorporated by reference herein, as if reproduced in full hereinbelow, which claims priority from the U.S. Provisional Application No. 60/836,810, filed on 10 Aug. 2006, entitled “METHOD FOR PREPARING VISCOELASTIC POLYURETHANE FOAM,” the teachings of which are incorporated by reference herein, as if reproduced in full hereinbelow.

This invention relates to viscoelastic polyurethane foam and methods for preparing those foams.

Polyurethane foams are used in a wide variety of applications, ranging from cushioning (such as mattresses, pillows and seat cushions) to packaging to thermal insulation. Polyurethanes have the ability to be tailored to particular applications through the selection of the raw materials that are used to form the polymer. Rigid types of polyurethane foams are used as appliance insulation foams and other thermal insulating applications. Semi-rigid polyurethanes are used in automotive applications such as dashboards and steering wheels. More flexible polyurethane foams are used in cushioning applications, notably furniture, bedding and automotive seating.

One class of polyurethane foam is known as viscoelastic (VE) or “memory” foam. Viscoelastic foams exhibit a time-delayed and rate-dependent response to an applied stress. They have low resiliency and recover slowly when compressed. These properties are often associated with the glass transition temperature (T_{g}) of the polyurethane. Viscoelasticity is often manifested when the polymer has a T_{g} at or near the use temperature, which is room temperature for many applications.

Like most polyurethane foams, VE polyurethane foams are prepared by the reaction of a polyol component with a polyisocyanate, in the presence of a blowing agent. The blowing agent is usually water or, less preferably, a mixture of water and another material. VE formulations are often characterized by the selection of polyol component and the amount of water in the formulation. The predominant polyol used in these formulations has a functionality of about 3 hydroxyl groups/molecule and a molecular weight in the range of 400-1500. This polyol is primarily the principal determinant of the T_{g} of the polyurethane foam, although other factors such as water levels and isocyanate index also play significant roles.

Water levels in VE foams are typically no greater than about 2.5 parts per 100 parts by weight of the polyol(s), and most often are in the 0.8-1.5 parts range. This is quite a bit lower than the water levels that are typically used in flexible foam formulations, in which the water level is typically in the 4 to 6 part range (per 100 parts by weight polyol). The lower water level favors the development of the desired viscoelastic properties in the foam, in part due to a phenomenon sometimes referred to as “phase mixing”. The lower amount of water produces less blowing gas, and so VE foams tend to have higher densities (about 3.5-6 pound/cubic foot or higher) than most flexible foams (which tend to have densities in the 1-2.5 pcf range). The higher density is desirable in many applications, such as mattresses, where it contributes to the durability of the product and its ability to support applied loads.

Viscoelastic polyurethane foam formulations are notoriously difficult to process at commercial scale. The foaming and curing reactions are very sensitive to small variations in composition (particularly catalyst level) and process conditions. This makes it difficult to operate a continuous foaming process, because precise control over those variables is hard to maintain. The problem is generally attributed to the combination of low equivalent weight polyol (compared to flexible foam polyols) and low water levels, and is acerbated when a low isocyanate index is used. There are, relative to the amount of water, far more polyol hydroxyl groups available for reaction with the polyisocyanate in a VE formulation than in a conventional flexible foam formulation. The increased competition between the polyol and water for available isocyanate groups retards the development of blowing gases and chain extension that each occur due to the water/isocyanate reaction. The resulting changes in the balancing of the blowing and gelling reactions can cause the foam to expand incompletely, collapse, or become dimensionally unstable.

Various approaches have been taken to overcome the processing difficulties. One approach is to reduce the isocyanate index. VE foam formulations typically are run on commercial scale equipment at an isocyanate index in the range of 60 to 90. Isocyanate index is 100 times the ratio of equivalents of polyisocyanate groups to equivalents of isocyanate-reactive groups in the VE foam formulation, including those provided by the water, polyols and other isocyanate-reactive materials that may be present. This approach can make the formulation easier to process, but comes at the expense of physical properties such as tensile strength, elongation and tear strength.

A second approach involves the selection of the polyisocyanate, and is generally used in combination with a low isocyanate index. Formulations based on methylene diphenyl diisocyanate (MDI) often are more easily processable than those based on toluene diisocyanate (TDI). Among TDI-based formulations, those using a TDI that is relatively rich in the 2,6-isomer tend to be more easily processable than those which are based on the more common (and less costly) 80/20 mixture of the 2,4- and 2,6-isomers of TDI (80/20 TDI).

A third approach (which is often used in conjunction with one or both of the others) is to add a monofunctional alcohol into the foam formulation. The effect of this is similar to reducing the isocyanate index, in that improvements in foam processing come at the expense of some physical properties.

Yet another approach is to increase the water content of the formulation somewhat, and so produce a foam having a density in the 2-3 pounds/cubic foot (37-48 kg/m³) range. Increasing the water level improves processing, but the foams tend to exhibit poorer viscoelastic behavior. These foam densities are also too low to be suitable for some end-use applications such as mattresses, where durability is a needed attribute.

It would be desirable to provide a VE foam formulation which is more easily processable, and can be used with a wider variety of polyisocyanates. A VE foam formulation that processes easily using 80/20 TDI as the polyisocyanate is of particular interest. It would be further desirable if that formulation could be used at a wider range of isocyanate indices, including higher isocyanate indices such as from 85 to 105 or even higher, even when 80/20 TDI is the polyisocyanate in the formulation.

This invention is a process for preparing a viscoelastic polyurethane foam, comprising

A. forming a reaction mixture including at least one polyol, at least one polyisocyanate, water, at least one catalyst and at least one additive, different from the catalyst and different from the polyol(s), selected from

1) alkali metal or transition metal salts of carboxylic acids;

2) 1,3,5-tris alkyl- or 1,3,5-tris (N,N-dialkyl amino alkyl)-hexahydro-s-triazine compounds; and

3) carboxylate salts of quaternary ammonium compounds;

wherein the additive is dissolved in at least one other component of the reaction mixture and
B. subjecting the reaction mixture to conditions sufficient to cause the reaction mixture to expand and cure to form a viscoelastic polyurethane foam.

This invention is also a process for preparing a viscoelastic polyurethane foam, comprising subjecting a reaction mixture to conditions sufficient for the reaction mixture to expand and cure, wherein the reaction mixture comprises:

a) at least one base polyol having a hydroxyl functionality from about 2.5 to 4 and a molecular weight of from 400 to 1500, or a mixture containing at least 50% by weight of said at least one base polyol and at least one other monoalcohol or polyol different from component e) and having a hydroxyl equivalent weight of at least 200;

b) at least one organic polyisocyanate;

c) from 0.8 to about 2.25 parts by weight of water per 100 parts by weight of component a);

d) at least one catalyst different than component e); and

e) an amount of an additive sufficient to reduce the blow-off time of the reaction mixture, wherein the additive is selected from

1) alkali metal or transition metal salts of carboxylic acids;

2) 1,3,5-tris alkyl- or 1,3,5-tris (N,N-dialkyl amino alkyl)-hexahydro-s-triazine compounds; and

3) carboxylate salts of quaternary ammonium compounds, wherein said additive is dissolved in at least one other component of the reaction mixture.

Applicants have found that very significant improvements in processing latitude can be obtained by including the component e) material into the VE foam formulation. The foam formulation in many cases becomes less sensitive to process variables, particularly amine catalyst level and isocyanate index, and thus is easier to process on a commercial scale. In some embodiments, it is possible to reduce the amount of amine catalyst that is used, or even eliminate it. The improved processing is seen particularly in lower water formulations, which produce VE foams having a density of 3.5 pcf or higher, up to about 8 pcf, which conventionally have presented especially difficult processing characteristics.

The presence of the component e) material also permits a wider range of polyisocyanates to be used, including 80/20 TDI, at a wider range of isocyanate indices. Because the formulations process well even at an index of 85 to 110, it is possible with the invention to produce foams having higher tensile and tear strengths. Similarly, monofunctional alcohols can be avoided if desired, which also tends to lead to increases in tensile and tear strength.

The ability to process these formulations at higher isocyanate index has a further benefit of reducing the production of toluene diamine (TDA) as a reaction by-product. TDA contributes to odor and its presence is a health and safety concern.

The VE foam formulation includes at least one polyol. As the polyol is believed to primarily determine the T_{g} of the foam, and therefore the foam's viscoelastic behavior, the polyol is in most cases selected to provide the foam with a T_{g} in the range of from −20 to 40° C., especially from 0 to 25° C. A class of polyols that provide such a T_{g} to the foam include those having a functionality of from 2.5 to 4 hydroxyl groups per molecule and a molecular weight from 400 to 1500. The polyol component therefore preferably contains at least one such polyol, which is referred to herein as a “base” polyol. The base polyol(s) preferably have a molecular weight from 600 to 1100 and more preferably from 650 to 1000. Polyol molecular weights herein are all number average molecular weights.

The base polyol may be a polyether or polyester type. Hydroxy-functional acrylate polymers and copolymers are suitable. The base polyol preferably is a polymer of propylene oxide or ethylene oxide, or a copolymer (random or block) of propylene oxide and ethylene oxide. The base polyol may have primary or secondary hydroxyl groups, but preferably has mainly secondary hydroxyl groups.

A base polyol may be used as a mixture with one or more additional monoalcohols or polyols that have a hydroxyl equivalent weight of at least 150. The additional monoalcohol(s) or polyol(s) may be used to perform various functions such as cell-opening, providing additional higher or lower temperature glass transitions to the polyurethane, modifying the reaction profile of the system and modifying polymer physical properties, or to perform other functions. The additional monoalcohol(s) or polyol(s) are different from the base polyol, i.e., do not satisfy the molecular weight and/or functionality requirements of the base polyol(s). Generally, the additional monoalcohol(s) or polyol(s) may have a hydroxyl equivalent weight of from 200 to 3000 or more and a functionality of from 1 to 8 or more hydroxyl groups per molecule. An additional monoalcohol or polyol may have, for example, a hydroxyl equivalent weight of 500 to 3000, especially from 800 to 2500, and a functionality of from 1 to 8, especially from 2 to 4, hydroxyl groups per molecule. Another suitable additional monoalcohol or polyol has a functionality of from 1 to 2 hydroxyl groups per molecule and a hydroxyl equivalent weight from 200 to 500. The additional monoalcohol or polyol does not contain carboxylate groups in measurable quantities.

The additional monoalcohol or polyol may be a polymer of one or more alkylene oxides such as ethylene oxide, propylene oxide and 1,2-butylene oxide, or mixtures of such alkylene oxides. Preferred polyethers are polypropylene oxides or polymers of a mixture of propylene oxide and ethylene oxide. The additional monoalcohol or polyol may also be a polyester. These polyesters include reaction products of polyols, preferably diols, with polycarboxylic acids or their anhydrides, preferably dicarboxylic acids or dicarboxylic acid anhydrides. The polycarboxylic acids or anhydrides may be aliphatic, cycloaliphatic, aromatic and/or heterocyclic and may be substituted, such as with halogen atoms. The polycarboxylic acids may be unsaturated. Examples of these polycarboxylic acids include succinic acid, adipic acid, terephthalic acid, isophthalic acid, trimellitic anhydride, phthalic anhydride, maleic acid, maleic acid anhydride and fumaric acid. The polyols used in making the polyester polyols preferably have an equivalent weight of 150 or less and include ethylene glycol, 1,2- and 1,3-propylene glycol, 1,4- and 2,3-butane diol, 1,6-hexane diol, 1,8-octane diol, neopentyl glycol, cyclohexane dimethanol, 2-methyl-1,3-propane diol, glycerine, trimethylol propane, 1,2,6-hexane triol, 1,2,4-butane triol, trimethylolethane, pentaerythritol, quinitol, mannitol, sorbitol, methyl glycoside, diethylene glycol, triethylene glycol, tetraethylene glycol, dipropylene glycol, dibutylene glycol and the like. Polycaprolactone polyols such as those sold by The Dow Chemical Company under the trade name “Tone” are also useful.

Hydroxyl-functional polybutadiene polymers are also useful additional monoalcohols and polyols.

Additional monoalcohols and polyols of particular interest include:

a1) poly(propylene oxide) homopolymers or random copolymers of propylene oxide and up to 20% by weight ethylene oxide, having a functionality of from 2 to 4 and an equivalent weight of 800 to 2200;

a2) homopolymers of ethylene oxide or copolymers (random or block) of ethylene oxide and up to 50% by weight a C₃ or higher alkylene oxide, having a functionality of from 3 to 8, especially from 5 to 8, and an equivalent weight of from 1000 to 3000;

a3) a homopolymer of ethylene oxide or propylene oxide, or random copolymer of ethylene oxide and propylene oxide, having a functionality of about 1 and a molecular weight of 200 to 3000, especially from 1000-3000, including those monoalcohols of the type described in WO 01/57104;

a4) a polymer polyol containing a monoalcohol or polyol having an equivalent weight of 500 or greater and a disperse polymer phase. The disperse polymer phase may be particles of an ethylenically unsaturated monomer (of which styrene, acrylonitrile and styrene-acrylonitrile copolymers are of particular interest), polyurea particles, or polyurethane particles. The disperse phase may constitute from 5 to 60% by weight of the polymer polyol;

a5) mixture of any two or more of the foregoing.

If the base polyol(s) are used together with one or more additional monoalcohol(s) or polyol(s), the base polyol preferably constitutes at least 50% of their combined weight, and more preferably at least 70% of their combined weight. The additional monoalcohol(s) and polyol(s) together preferably constitute no more than 50%, preferably no more than about 30%, of the weight of component a).

Component b) is an organic polyisocyanate having an average of 1.8 or more isocyanate groups per molecule. The isocyanate functionality is preferably from about 1.9 to 4, and more preferably from 1.9 to 3.5 and especially from 1.9 to 2.5. Suitable polyisocyanates include aromatic, aliphatic and cycloaliphatic polyisocyanates. Aromatic polyisocyanates are generally preferred based on cost, availability and properties imparted to the product polyurethane. Exemplary polyisocyanates include, for example, m-phenylene diisocyanate, 2,4- and/or 2,6-toluene diisocyanate (TDI), the various isomers of diphenylmethanediisocyanate (MDI), hexamethylene-1,6-diisocyanate, tetramethylene-1,4-diisocyanate, cyclohexane-1,4-diisocyanate, hexahydrotoluene diisocyanate, hydrogenated MDI (H₁₂ MDI), naphthylene-1,5-diisocyanate, methoxyphenyl-2,4-diisocyanate, 4,4′-biphenylene diisocyanate, 3,3′-dimethoxy-4,4′-biphenyl diisocyanate, 3,3′-dimethyldiphenylmethane-4,4′-diisocyanate, 4,4′,4″-triphenylmethane tri-isocyanate, polymethylene polyphenylisocyanates, hydrogenated polymethylene polyphenylisocyanates, toluene-2,4,6-triisocyanate, and 4,4′-dimethyl diphenylmethane-2,2′,5,5′-tetraisocyanate. Preferred polyisocyanates include MDI and derivatives of MDI such as biuret-modified “liquid” MDI products and polymeric MDI, as well as mixtures of the 2,4- and 2,6-isomers of TDI.

A polyisocyanate of particular interest is a mixture of 2,4- and 2,6-toluene diisocyanate containing at least 80% by weight of the 2,4-isomer. These polyisocyanate mixtures are widely available and are relatively inexpensive, yet have heretofore been difficult to use in commercial scale VE foam processes due to difficulties in processing the foam formulation.

The foam formulation includes water, in an amount from about 0.8 to about 2.25 parts per 100 parts by weight of the polyol or polyol mixture. The invention is of particular interest in formulations in which the water content is from about 0.8 to about 1.8 parts, especially from 0.8 to 1.5 parts, most preferably from 0.8 to 1.3, parts by weight per 100 parts by weight polyol Conventional VE foam formulations containing these levels of water often tend to exhibit particular processing difficulties.

At least one catalyst is present in the foam formulation. One preferred type of catalyst is a tertiary amine catalyst. The tertiary amine catalyst may be any compound possessing catalytic activity for the reaction between a polyol and a polyisocyanate and at least one tertiary amine group, other than a component e2) compound. Representative tertiary amine catalysts include trimethylamine, triethylamine, N-methylmorpholine, N-ethylmorpholine, N,N-dimethylbenzylamine, N,N-dimethylethanolamine, N,N,N′,N′-tetramethyl-1,4-butanediamine, N,N-dimethylpiperazine, 1,4-diazobicyclo-2,2,2-octane, bis(dimethylaminoethyl)ether, bis(2-dimethylaminoethyl)ether, morpholine, 4,4′-(oxydi-2,1-ethanediyl)bis, triethylenediamine, pentamethyl diethylene triamine, dimethyl cyclohexyl amine, N-cetyl N,N-dimethyl amine, N-coco-morpholine, N,N-dimethyl aminomethyl N-methyl ethanol amine, N,N,N′-trimethyl-N′-hydroxyethyl bis(aminoethyl)ether, N,N-bis(3-dimethylaminopropyl)N-isopropanolamine, (N,N-dimethyl)amino-ethoxy ethanol, N, N,N′,N′-tetramethyl hexane diamine, 1,8-diazabicyclo-5,4,0-undecene-7, N,N-dimorpholinodiethyl ether, N-methyl imidazole, dimethyl aminopropyl dipropanolamine, bis(dimethylaminopropyl)amino-2-propanol, tetramethylamino bis (propylamine), (dimethyl(aminoethoxyethyl))((dimethyl amine)ethyl)ether, tris(dimethylamino propyl) amine, dicyclohexyl methyl amine, bis(N,N-dimethyl-3-aminopropyl) amine, 1,2-ethylene piperidine and methyl-hydroxyethyl piperazine.

It has been found that in some embodiments of the invention, lower levels of tertiary amine catalyst are sometimes needed (compared to formulations that do not include the component e) material), so stable processing and good foam properties can be obtained using reduced amounts of the tertiary amine catalyst. In some instances, the tertiary amine catalyst can be eliminated altogether, which provides benefits in reduced cost and odor reduction in the product foam.

The foam formulation may contain one or more other catalysts, in addition to the tertiary amine catalyst mentioned before. The other catalyst is a compound (or mixture thereof) having catalytic activity for the reaction of an isocyanate group with a polyol or water, but is not a compound falling within the description of components e1)-e3). Suitable such additional catalysts include, for example:

d1) tertiary phosphines such as trialkylphosphines and dialkylbenzylphosphines;
d2) chelates of various metals, such as those which can be obtained from acetylacetone, benzoylacetone, trifluoroacetyl acetone, ethyl acetoacetate and the like, with metals such as Be, Mg, Zn, Cd, Pd, Ti, Zr, Sn, As, Bi, Cr, Mo, Mn, Fe, Co and Ni;
d3) acidic metal salts of strong acids, such as ferric chloride, stannic chloride, stannous chloride, antimony trichloride, bismuth nitrate and bismuth chloride;
d4) strong bases, such as alkali and alkaline earth metal hydroxides, alkoxides and phenoxides;
d5) alcoholates and phenolates of various metals, such as Ti(OR)₄, Sn(OR)₄ and Al(OR)₃, wherein R is alkyl or aryl, and the reaction products of the alcoholates with carboxylic acids, beta-diketones and 2-(N,N-dialkylamino) alcohols;
d6) alkaline earth metal, Bi, Pb, Sn or Al carboxylate salts; and
d7) tetravalent tin compounds, and tri- or pentavalent bismuth, antimony or arsenic compounds.

Of particular interest are tin carboxylates and tetravalent tin compounds. Examples of these include stannous octoate, dibutyl tin diacetate, dibutyl tin dilaurate, dibutyl tin dimercaptide, dialkyl tin dialkylmercapto acids, dibutyl tin oxide, dimethyl tin dimercaptide, dimethyl tin diisooctylmercaptoacetate, and the like.

Catalysts are typically used in small amounts. For example, the total amount of catalyst used may be 0.0015 to 5, preferably from 0.01 to 1 part by weight per 100 parts by weight of polyol or polyol mixture. Organometallic catalysts are typically used in amounts towards the low end of these ranges.

The foam formulation further includes an additive, which is not a compound falling within the description of component d), selected from

e1) alkali metal or transition metal salts of carboxylic acids.

e2) 1,3,5-tris alkyl- or 1, 3-5 tris (N,N-dialkyl amino alkyl)-hexahydro-s-triazine compounds; and

e3) carboxylate salts of quaternary ammonium compounds.

The e1) type of additive can be a salt of a mono- or polycarboxylic acid. It is preferably soluble in water or the base polyol. The cation of the salt is an alkali metal or a transition metal. Alkali metals are those contained within group I of the IUPAC version of the periodic table, and include lithium, sodium, potassium and cesium. Transition metals include those contained within groups 3-12 of the IUPAC version of the periodic of the table, and include, for example, scandium, titanium, zirconium, vanadium, chromium, molybdenum, tungsten, manganese, iron, cobalt, nickel, copper, silver, zinc, cadmium and mercury, Preferred metal cations include lithium, sodium, potassium, cesium, zinc, copper, nickel, silver and the like.

There are two generally preferred kinds of the e1) type of additive. The first preferred type is a salt of a C₂₋₂₄ monocarboxylic acid, particularly of a C₂₋₁₈ monocarboxylic acid and especially of a C₂₋₁₂ carboxylic acid. The monocarboxylic acid may be aliphatic or aromatic (such as benzoic acid or a substituted benzoic acid such as nitrobenzoic acid, methylbenzoic acid or chlorobenzoic acid). Suitable aliphatic monocarboxylic acids include saturated or unsaturated types, linear or branched types, and may be substituted. Specific examples of this first type of e1) additive include sodium acetate, lithium acetate, potassium acetate, lithium hexanoate, sodium hexanoate, potassium hexanoate, lithium hexanoate, sodium hexanoate, potassium octoate, zinc stearate, zinc laurate, zinc octoate, nickel octoate, nickel stearate, nickel laurate, cesium octoate, cesium stearate, cesium laurate, copper acetate, copper hexanoate, copper octoate, copper stearate, copper laurate, silver acetate, silver hexanoate, silver octoate, silver stearate, silver laurade, lithium, sodium or potassium benzoate, lithium, sodium or potassium nitrobenzoate lithium, sodium or potassium methylbenzoate and lithium, sodium or potassium chlorobenzoate, and the like.

The second preferred kind of e1) additive is a salt of a carboxyl-functional organic polymer. The organic polymer can be, for example, an acrylic acid polymer or copolymer. Another type of organic polymer is a polyether or polyester which contains terminal or pendant carboxyl groups. An example of the latter type is a polyol which has been reacted with a dicarboxylic acid or anhydride to form carboxyl groups at the site of some or all of the hydroxyl groups of the starting polyol. The starting polyol may be any of the types of polyols described before, including polyether, polyester or polyacrylate types. The carboxyl-functional organic polymer may have an equivalent weight per carboxyl group of from 150 to 5000. A particularly preferred carboxyl-functional organic polymer is a polyether polyol having a carboxyl equivalent weight of from 500 to 3000 and a carboxyl functionality of from 1 to 4. Such particularly preferred carboxyl-functional organic polymer most preferably has one or more hydroxyl groups in addition to the carboxyl groups.

An example of the e2) type of additive is 1,3,5-tris (3-dimethylaminopropyl)hexahydro-s-triazine.

The e3) additive may be a quaternary ammonium salt of a mono- or polycarboxylic acid. It is preferably soluble in water or the base polyol. There are two generally preferred kinds of the e3) type of additive. The first preferred type is a salt of a C₁₋₁₂ monocarboxylic acid, and especially of a C₂₋₁₂ monocarboxylic acid. Examples of the first preferred e3) type of additive include, for example, trimethyl hydroxyethyl ammonium carboxylate salts, such as are commercially available as Dabco® TMR and TMR-2 catalysts. The second preferred type is a quaternary ammonium salt of a carboxyl-functional organic polymer as described with respect to the e1) additive.

The component e) additive in most cases is used in very small amounts, such as from 0.01 to 1.0 part per hundred parts by weight polyol or polyol mixture. A preferred amount of the component e) additive is from 0.01 to 0.5 parts per 100 parts by weight polyol or polyol mixture. A more preferred amount is from 0.025 to 0.25 parts. In some cases higher amounts of the component e) additive can be used, such as is the case when e1) or e3) additives based on a carboxyl-functional organic polymer are used. This is particularly true when the organic polymer has an equivalent weight per carboxyl group of 500 or more. In such cases, the amount of the additive may be as much as 25 parts, preferably to 10 parts and more preferably to 5 parts by weight per 100 parts by weight polyol or polyol mixture.

The component e) additive is dissolved in at least one other component of the reaction mixture. It is generally not preferred to dissolve it in the polyisocyanate. The component e) additive may be dissolved in water, the base polyol, any additional polyol that may be present, the catalyst, a surfactant, a crosslinker or chain extender, or a non-reactive solvent.

Various additional components may be included in the VE foam formulation. These include, for example, chain extenders, crosslinkers, surfactants, plasticizers, fillers, colorants, preservatives, odor masks, flame retardants, biocides, antioxidants, UV stabilizers, antistatic agents, thixotropic agents and cell openers.

The foamable composition may contain a chain extender or crosslinker, but their use is generally not preferred, and these materials are typically used in small quantities (such as up to 10 parts, especially up to 2 parts, by weight per 100 parts by weight polyol or polyol mixture) when present at all. A chain extender is a material having exactly two isocyanate-reactive groups/molecule, whereas a crosslinker contains on average greater than two isocyanate-reactive groups/molecule. In either case, the equivalent weight per isocyanate-reactive group can range from about 30 to about 125, but is preferably from 30 to 75. The isocyanate-reactive groups are preferably aliphatic alcohol, primary amine or secondary amine groups, with aliphatic alcohol groups being particularly preferred. Examples of chain extenders and crosslinkers include alkylene glycols such as ethylene glycol, 1,2- or 1,3-propylene glycol, 1,4-butanediol, 1,6-hexanediol, and the like; glycol ethers such as diethylene glycol, triethylene glycol, dipropylene glycol, tripropylene glycol and the like; cyclohexane dimethanol; glycerine; trimethylolpropane; triethanolamine; diethanolamine and the like.

A surfactant is preferably included in the VE foam formulation to help stabilize the foam as it expands and cures. Examples of surfactants include nonionic surfactants and wetting agents such as those prepared by the sequential addition of propylene oxide and then ethylene oxide to propylene glycol, solid or liquid organosilicones, and polyethylene glycol ethers of long chain alcohols. Ionic surfactants such as tertiary amine or alkanolamine salts of long chain alkyl acid sulfate esters, alkyl sulfonic esters and alkyl arylsulfonic acids can also be used. The surfactants prepared by the sequential addition of propylene oxide and then ethylene oxide to propylene glycol are preferred, as are the solid or liquid organosilicones. Examples of useful organosilicone surfactants include commercially available polysiloxane/polyether copolymers such as Tegostab (trademark of Goldschmidt Chemical Corp.) B-8462 and B-8404, and DC-198 and DC-5043 surfactants, available from Dow Corning, and Niax™ 627 surfactant from OSi Specialties.

Non-hydrolyzable liquid organosilicones are more preferred. When a surfactant is used, it is typically present in an amount of 0.0015 to 1 part by weight per 100 parts by weight polyol or polyol mixture.

One or more fillers may also be present in the VE foam formulation. A filler may help modify the composition's rheological properties in a beneficial way, reduce cost and impart beneficial physical properties to the foam. Suitable fillers include particulate inorganic and organic materials that are stable and do not melt at the temperatures encountered during the polyurethane-forming reaction. Examples of suitable fillers include kaolin, montmorillonite, calcium carbonate, mica, wollastonite, talc, high-melting thermoplastics, glass, fly ash, carbon black titanium dioxide, iron oxide, chromium oxide, azo/diazo dyes, phthalocyanines, dioxazines and the like. The filler may impart thixotropic properties to the foamable polyurethane composition. Fumed silica is an example of such a filler. When used, fillers advantageously constitute from about 0.5 to about 30%, especially about 0.5 to about 10%, by weight of the composition.

Although it is preferred that no additional blowing agent (other than the water) be included in the foamable polyurethane composition, it is within the scope of the invention to include an additional physical or chemical blowing agent. Among the physical blowing agents are supercritical CO₂ and various hydrocarbons, fluorocarbons, hydrofluorocarbons, chlorocarbons (such as methylene chloride), chlorofluorocarbons and hydrochlorofluorocarbons. Chemical blowing agents are materials that decompose or react (other than with isocyanate groups) at elevated temperatures to produce carbon dioxide and/or nitrogen.

The VE foam can be prepared in a so-called slabstock process, or by various molding processes. Slabstock processes are of most interest. In a slabstock process, the components are mixed and poured into a trough or other region where the formulation reacts, expands freely in at least one direction, and cures. Slabstock processes are generally operated continuously at commercial scales.

In a slabstock process, the various components are introduced individually or in various subcombinations into a mixing head, where they are mixed and dispensed. The e) component preferably is dissolved in one or more of the other components. Component temperatures are generally in the range of from 15 to 35° C. prior to mixing. The dispensed mixture typically expands and cures without applied heat. In the slabstock process, the reacting mixture expands freely or under minimal restraint (such as may be applied due to the weight of a cover sheet or film).

In a slabstock process, the e) additive can be mixed into the reaction mixture in several ways. It can be delivered into the mixing head as a separate stream, or may be pre-blended with one or more other components, such as the base polyol(s), additional polyol(s), surfactants or catalyst streams. When the e) additive is a salt of an organic polymer which contains carboxyl and hydroxyl groups, it can be pre-reacted with all or a portion of the polyisocyanate to form a prepolymer. When such prepolymer molecules are formed, they will be formed as a solution in the polyisocyanate compound

It is also possible to produce the VE foam in a molding process, by introducing the reaction mixture into a closed mold where it expands and cures. In a molding process, it is typical to mix the additive e) with the polyol(s), water and other components (except the polyisocyanate) to form a formulated polyol stream which is mixed with the polyisocyanate immediately before filling the mold. A prepolymer can be formed from the e) additive in cases where it is a salt of an organic polymer which contains carboxyl and hydroxyl groups.

The amount of polyisocyanate that is used typically is sufficient to provide an isocyanate index of from 50 to 120. A preferred range is from 70 to 110 and a more preferred range is from 75 to 105. An advantage of the invention is that good processing can be achieved in commercial scale, continuous operations even at somewhat high isocyanate indices, such as 85 to 105 or even higher. Good processing can be achieved at these indices, even using a TDI mixture containing 80% or more of the 2,4-isomer, and the use of higher indices usually leads to improvements in foam properties, notably tensile, tear and elongation. The good processing can also be achieved using relatively low amounts of water, such as up to 1.5 parts per 100 parts by weight polyol or polyol mixture, or up to 1.3 parts per 100 parts by weight polyol or polyol mixture. Good processing is often seen even in an 85 to 110 index, low water (up to 1.8 parts, especially up to 1.5 parts, most preferably up to 1.3 parts) formulation that uses a TDI containing 80% or more of the 2,4-isomer as the polyisocyanate.

Good processing is indicated by the ability to produce stable, consistent quality foam over an extended period of operation in a continuous process. Previous VE foam formulations tend to be very sensitive to fluctuations in amine catalyst level which are often due to small errors in metering, imperfect mixing, or for other reasons.

Foam made in accordance with the invention tends to exhibit markedly faster blow-off than similar foams made without using the component e) additive. Blow-off time is determined by observing the time required, after mixing and dispensing the formulation, for bubbles to rise to the surface of the expanding mass. Faster blow-off is an indication that the blowing reaction is proceeding and that a stable foam will be produced. Formulations that blow-off quickly tend to use the surfactant more efficiently, and for that reason surfactant concentrations often can be reduced in systems that blow-off faster.

The process of the invention also tends to produce foams having a finer cell structure than foams made without using the component e) additive. The finer cell structure is a further indication of the good processing characteristics achieved with the invention. Finer cell structure often contributes to better physical properties in the foam, such as softness.

In batch processes such as box foams, which are often used to screen foam formulations, faster blow-off times and fine cell structures are good indicators of whether the foam formulation will process well in a continuous operation.

The cured VE foam is characterized in having very low resiliency. Resiliency is conveniently determined using a ball rebound test, such as ASTM D-3574-H, which measures the height a ball rebounds from the surface of the foam when dropped under specified conditions. Under the ASTM test, the cured VE foam exhibits a resiliency of no greater than 20%, especially no greater than 10%. Especially preferred VE foams exhibit a resiliency according to the ASTM ball rebound test of no greater than 5%, especially no greater than 3%.

Another indicator of viscoelasticity is the time required for the foam to recover after being compressed. A useful test for evaluating this is the so-called compression recovery test of ASTM D-3574M, which measures the time required for the foam to recover from an applied force. According to the ASTM method, the foam sample is compressed to a certain proportion of its initial thickness, held at the compressed thickness for a specified period, and then the compression foot is released to approximately the initial height of the foam sample. The foam re-expands and at approximately full re-expansion applies a force against the withdrawn foot. The time required until this applied force reaches 4.5 Newtons is the compressive recovery time. This time is desirably at least 3 seconds, more preferably at least 5 seconds, even more preferably at least 7 seconds and still more preferably at least 10 seconds, but less than 30 seconds and preferably less than 20 seconds.

The cured VE foam advantageously has a density in the range of 3.0 to 8 pounds/cubic foot (pcf) (48-128 kg/m³), preferably from 3.5 to 6 pounds/cubic foot (56-96 kg/m³) and more preferably from 4 to 5.5 pounds/cubic foot (64-88 kg/m³). Density is conveniently measured according to ASTM D 3574-01 Test A.

A particularly desirable VE foam for many applications has a density of from 3.5 to 6 pounds per cubic foot (56-96 kg/m³) and a resiliency of less than 10% on the ASTM ball rebound test. A more desirable VE foam for many applications further exhibits a recovery time of at least 5 seconds but not more than 30 seconds on the ASTM compression recovery test. A particularly desirably VE foam has a density of from 4 to 5.5 pounds/cubic foot (64-88 kg/m³), a resiliency of less than 8% on the ASTM ball rebound test and a recovery time of at least 7 seconds but not more than 20 seconds on the ASTM compression recovery test.

VE foams produced in accordance with the invention often exhibit higher tensile strength and greater load bearing (as indicated by indention force defection, ASTM D-3574-01 Test B), the latter particularly at 65% deflection. Support factors (the ratio of 65% to 25% IFD) also tend to be significantly higher. These improvements are often seen even at equivalent isocyanate indices. Tensile, load bearing and tear strength also tend to increase with increasing isocyanate index. Because higher index formulations are more readily processed in accordance with the invention, still further improvements in tensile, IFD and often tear strength can be achieved by increasing the isocyanate index.

Although many of the component e) additives are known to catalyze the trimerization reaction of three isocyanate groups to form an isocyanurate ring, analysis of VE foam produced in accordance with the invention shows little or no measurable quantities of isocyanurate groups. It is therefore believed that isocyanate trimerization is does not account for, or accounts for very little, of, the processing and physical property benefits provided by the invention.

VE foam made in accordance with the invention are useful in a variety of packaging and cushioning applications, such as mattresses, packaging, bumper pads, sport and medical equipment, helmet liners, pilot seats, earplugs, and various noise and vibration dampening applications.

The following examples are provided to illustrate the invention, but are not intended to limit the scope thereof. All parts and percentages are by weight unless otherwise indicated.

### EXAMPLE 1

Viscoelastic Foam Examples 1-4 and Comparative Samples C-1 through C-4 are prepared using the following formulation.

| | | |
|---|---|---|
| Polyol A | 73.6 | parts by weight |
| Polyol B | 18.4 | parts by weight |
| Polyol C | 8.0 | parts by weight |
| Water | 1.25 | parts by weight |
| Surfactant A | 1.1 | parts by weight |
| Amine Catalyst A | 0.15 | parts by weight |
| Amine Catalyst B | 0.3 | parts by weight |
| Potassium Acetate Solution | 0 or 0.2 | parts by weight |
| Tin Catalyst A | 0.03 | parts by weight |

| | |
|---|---|
| TDI 80 | to index as indicated below |

Polyol A is a 700 molecular weight poly(propylene oxide) triol. Polyol B is a ˜990 equivalent weight, nominally trifunctional poly(propylene oxide). Polyol C is a ˜1800 equivalent weight, nominally 6.9 functional random copolymer of 75% ethylene oxide and 25% propylene oxide. Surfactant A is an organosilicone surfactant sold commercially by OSi Specialties as Niax® L-627 surfactant. Amine catalyst A is a 70% bis(dimethylaminoethyl)ether solution in dipropylene glycol, available commercially from OSi Specialties as Niax® A-1 catalyst. Amine catalyst B is a 33% solution of triethylene diamine in dipropylene glycol, available commercially from Air Products and Chemicals as Dabco® 33LV. The potassium acetate solution is a 38% solution in ethylene glycol. Tin Catalyst A is a stannous octoate catalyst available commercially from Air Products and Chemicals as Dabco® T-9 catalyst. TDI 80 is an 80/20 blend of the 2,4- and 2,6-isomers of toluene diisocyanate.

The foams are prepared by first blending the polyols, water, potassium acetate solution and amine catalysts in a high shear rate mix head. Component temperatures are approximately 22° C. This mixture is then blended in the same manner with the surfactant and tin catalyst, and the resulting mixture then blended, again in the same manner, with the polyisocyanate. The final blend is immediately poured into an open box and allowed to react without applied heat. Total formulation weights are 2000-2700 grams. The cured formulations are aged for a minimum of seven days and taken for property testing as indicated in Table 1. Physical property testing is conducted in accordance with ASTM D-3574-01.

TABLE 1

| | Ex. or Comp. Sample No. | | | | | | | |
|---|---|---|---|---|---|---|---|---|
| | 1 | C-1* | 2 | C-2* | 3 | C-3* | 4 | C-4* |
| Potassium | 0.2 | 0 | 0.2 | 0 | 0.2 | 0 | 0.2 | 0 |
| Acetate Solution, | | | | | | | | |
| parts by weight | | | | | | | | |
| 80/20 TDI (index) | 85 | 85 | 90 | 90 | 95 | 95 | 100 | 100 |
| Blow off, s | 94 | 168 | 86 | 149 | 82 | 132 | 75 | 120 |
| Airflow, ft³/min | 0.39 | 0.87 | 0.39 | 0.75 | 0.44 | 0.57 | 0.55 | 0.50 |
| (L/min) | (11.0) | (24.6) | (11.0) | (21.2) | (12.5) | (16.1) | (15.6) | (14.7) |
| Density, lb/ft³ | 6.04 | 4.35 | 5.40 | 4.32 | 4.97 | 4.35 | 4.92 | 4.43 |
| (kg/m³) | (96.7) | (69.6) | (86.5) | (69.2) | (79.6) | (69.6) | (78.8) | (70.9) |
| IFD | | | | | | | | |
| 25% | 12.0 | 10.7 | 22.1 | 15.6 | 35.1 | 24.3 | 50.1 | 32.1 |
| 65% | 48.8 | 24.9 | 69.5 | 37.2 | 94.9 | 53.9 | 127.2 | 71.3 |
| return 25% | 10.4 | 9.9 | 20.0 | 14.5 | 31.8 | 22.6 | 44.9 | 29.3 |
| Resiliency, % | 3 | 4 | 8 | 3 | 9 | 3 | 7 | 3 |
| Tear Str., N/m | 166 | 139 | 218 | 172 | 293 | 249 | 338 | 320 |
| Tensile Str., kPa | 91 | 52 | 111 | 75 | 142 | 103 | 186 | 141 |
| Elongation, % | 154 | 170 | 127 | 160 | 114 | 158 | 111 | 139 |

*Not an example of the invention.

The data in Table 1 illustrates the effect of adding small amounts of potassium acetate into the VE foam formulation. Blow-off time is decreased significantly in all instances, compared to the respective controls. This is a clear indication that the foam formulations containing potassium acetate are more easily processable. The cell structure of the inventive foams is much finer than in the controls, which is a further indicator of good processing. Foam density is somewhat higher for the inventive foams, which means that more water (and polyisocyanate) is needed to achieve equivalent density when the potassium actetate is present. The ability to incorporate more water into the formulation to achieve an equivalent density will contribute to even better processing. Tensile and tear strengths are markedly increased over the controls, even taking the foam density differences into account.

### EXAMPLES 5-8 AND COMPARATIVE SAMPLE C-5

VE foams are prepared in the same manner described with respect to Examples 1-4. The foam formulation is the same as described with respect to Examples 1-4, except 1.4 parts of Surfactant A are used and the isocyanate index is 87. The amount of potassium acetate solution is varied as indicated in Table 2. Blow off time is determined and physical properties of the foams measured as before. Results are as indicated in Table 2.

TABLE 2

| | Ex. or Comp. Sample No. | | | | |
|---|---|---|---|---|---|
| | C-5* | 5 | 6 | 7 | 8 |
| Potassium Acetate | 0 | 0.1 | 0.2 | 0.3 | 0.4 |
| Solution, parts by weight | | | | | |
| Blow off, s | 200 | 140 | 140 | 130-180¹ | 107-127¹ |
| Airflow, ft³/min (L/min) | 0.58 (16.4) | 0.40 (11.3) | 0.39 (11.0) | 0.39 (11.0) | 0.31 (8.8) |
| Density, lb/ft³ (kg/m³) | 4.39 (70.3) | 4.65 (74.4) | 4.72 (75.6) | 4.61 (73.8) | 5.37 (86.0) |
| Resiliency, % | 3 | 4 | 4 | 5 | 6 |
| Tear Str., N/m | 172 | 180 | 173 | 188 | 193 |
| Tensile Str., kPa | 41 | 80 | 86 | 79 | 100 |
| Elongation, % | 153 | 145 | 152 | 144 | 147 |

*Not an example of the invention.
¹Range of times noted for duplicate samples.

Again, blow-off times are reduced very substantially when the potassium acetate is added to the VE foam formulation. In this set of experiments, density increases only slightly with the addition of potassium acetate to the 0.3 parts by weight level. Tensile strengths increase substantially and tear strengths generally improve with the addition of the potassium acetate. In addition, the inventive foams have a much finer cell structure than does the control.

### EXAMPLES 9-11 AND COMPARATIVE SAMPLE C-5

VE foams are prepared in the same manner described with respect to Examples 5-8, except (2-hydroxyalkyl) trialkyl ammonium formate (commercially available as Dabco™ TMR-5 from Air Products and Chemicals) is used in place of the potassium acetate. The amount of the quaternary ammonium salt is varied as indicated in Table 3. Blow off time is determined and physical properties of the foams measured as before. Results are as indicated in Table 3. Comparative Sample C-5 is again used as a control.

TABLE 3

| | Ex. or Comp. Sample No. | | | |
|---|---|---|---|---|
| | C-5* | 9 | 10 | 11 |
| Quaternary | 0 | 0.1 | 0.2 | 0.3 |
| Ammonium | | | | |
| Formate Salt, | | | | |
| parts by weight | | | | |
| Blow off, s | 200 | 149 | 140 | 160 |
| Airflow, | 0.58 (16.4) | 0.48 (13.6) | 0.56 (15.9) | 0.66 (18.7) |
| ft³/min (L/min) | | | | |
| Density, lb/ft³ | 4.39 (70.3) | 4.54 (72.7) | 4.34 (69.5) | 4.14 (66.3) |
| (kg/m³) | | | | |
| Resiliency, % | 3 | 4 | 4 | 4 |
| Tear Str., N/m | 172 | 187 | 211 | 165 |
| Tensile Str., | 41 | 63 | 65 | 62 |
| kPa | | | | |
| Elongation, % | 153 | 149 | 144 | 154 |

*Not an example of the invention.

The inclusion of the quaternary ammonium formate salt in the VE foam formulation leads to shorter blow-off times, increases in tensile strength and in most cases tear strength, and produces a finer cell structure. Foam densities are very close to that of the control when the quaternary ammonium salt is present.

### EXAMPLES 12-15

VE foams are prepared in the same manner described with respect to Examples 1-4, this time using various amounts of 1,3,5-tris (dimethylaminopropyl) hexahydro-s-triazine (commercially available as Polycat™ 41 from Air Products and Chemicals) in place of the potassium acetate. The foam formulation is the same as described with respect to Examples 1-4, except the isocyanate index is 90, and the level of Amine Catalyst B varies as indicated in Table 5. The amount of 1,3,5-tris (dimethylaminopropyl) hexahydro-s-triazine is varied as indicated in Table 4. Blow off time is determined and physical properties of the foams measured as before. In addition, compression recovery time is measured using the Compression Recovery method of ASTM D-3574M. Results are as indicated in Table 4.

TABLE 4

| | Ex. or Comp. Sample No. | | | |
|---|---|---|---|---|
| | 12 | 13 | 14 | 15 |
| Amine Catalyst B, parts | 0.3 | 0.2 | 0.1 | 0.0 |
| 1,3,5-tris (dimethylamino propyl) | 0.2 | 0.3 | 0.4 | 0.5 |
| hexahydro-s-triazine, parts | | | | |
| Blow off, s | 81 | 79 | 80 | 80 |
| Airflow, ft³/min (L/min) | 0.55 (15.6) | 0.57 (16.1) | 0.56 (15.8) | 0.57 (16.1) |
| Density, lb/ft³ (kg/m³) | 4.82 (77.2) | 4.71 (75.4) | 4.61 (73.8) | 4.46 (71.4) |
| Compression Recovery, s | 6 | 7 | 10 | 7 |
| IFD | | | | |
| 25% | 18.0 | 17.9 | 15.4 | 18.0 |
| 65% | 46.4 | 44.8 | 39.1 | 44.0 |
| return 25% | 16.2 | 15.8 | 13.6 | 15.8 |
| Support factor¹ | 2.58 | 2.51 | 2.53 | 2.44 |
| Hysteresis, % | 90 | 89 | 88 | 88 |
| Resiliency, % | 4 | 4 | 4 | 4 |
| Tear Str., N/m | 249 | 239 | 238 | 240 |
| Tensile Str., kPa | 93 | 88 | 90 | 90 |
| Elongation, % | 182 | 168 | 180 | 177 |

Ratio of 65% IFD to 25% IFD. Some small discrepancy exists due to rounding.

These examples show that the inclusion of the 1,3,5-tris (dimethylamino propyl) hexahydro-s-triazine permits the triethylene diamine catalyst level to be reduced or even eliminated, with little effect on physical properties. All foam formulations process well with good blow-off times and fine cell structure.

### EXAMPLE 16 AND COMPARATIVE SAMPLE C-6

VE foam Comparative Sample C-6 is made in the same manner as Comparative Sample C-3, except the isocyanate is a 65/35 blend of the 2,4- and 2,6-isomers of TDI (TDI 65). VE foam Example 16 is made in the same manner as Comparative Sample C-6, except Amine Catalyst B is eliminated and 0.4 parts of a 38% potassium acetate solution are used. Blow off time is determined and physical properties of the foams measured as before. Results are as indicated in Table 5.

TABLE 5

Ex. or Comp. Samp. No.

| | Example 16 | Comp. Sample C-6* |
|---|---|---|
| Amine Catalyst B, parts by | 0.0 | 0.3 |
| weight | | |
| Potassium Acetate Solution, | 0.4 | 0.0 |
| parts by weight | | |
| Blow-off, s | 96 | 146 |
| Airflow, ft³/min (L/min) | 0.48 (13.6) | 0.55 (15.6) |
| Density, lb/ft³ (kg/m³) | 5.17 (82.8) | 4.46 (71.4) |
| Compression Recovery, s | 6 | 5 |
| Resiliency, % | 13 | 4 |
| Tear Str., N/m | 266 | 245 |
| Tensile Str., kPa | 157 | 74 |
| Elongation, % | 129 | 118 |

*Not an example of the invention.

These results indicate that the use of potassium acetate provides benefits in a 65/35-TDI-based system, permitting elimination of triethylene diamine catalyst while increasing tensile strength. Cell structure is much finer for Example 16 than for Comparative Sample C-6, and blow-off time is significantly reduced. Both of these things indicate that the inventive system is more easily processable.

### EXAMPLE 17

A VE foam is made in the general manner described with respect to Examples 1-4, using the following formulation:

| | | |
|---|---|---|
| Polyol D | 95 | parts by weight |
| Polyol C | 5 | parts by weight |
| Water | 1.25 | parts by weight |
| Surfactant A | 1.1 | parts by weight |
| Sodium Acetate Solution | 0.13 | parts by weight |
| Tin Catalyst A | 0.05 | parts by weight |
| TDI 80 | to 92 | index |

Polyol D is a 1008 molecular weight, nominally trifunctional poly(propylene oxide). Physical properties are determined as described before.

Blow-off time for this formulation is 125 seconds. Airflow is 0.31 ft³/min (8.8 L/min). Compression Recovery time is 5 seconds. Density is 4.90 lb/ft³ (78.4 kg/m³). Resiliency on the ball rebound test is 15%. Tear strength is 184 N/m, tensile strength is 108 kPa and elongation is 113%.

These results show that a good quality foam that processes well can be made in accordance with the invention, even in the absence of a tertiary amine gelling catalyst.

### EXAMPLES 18-23 AND COMPARATIVE SAMPLE C-7

VE foams are prepared in the manner described in Example 17. The same formulation is used, except the isocyanate index is 92, 0.15 parts of Amine Catalyst A is present, and the sodium acetate solution is replaced with other additives as set forth in Table 6 below.

TABLE 6

| | Example or Comp. Sample No. | | | | | |
|---|---|---|---|---|---|---|
| | 18 | 19 | 20 | 21 | 22 | C-7* |
| Sodium | 0.3 | 0 | 0 | 0 | 0 | 0 |
| Octoate | | | | | | |
| Potassium | 0 | 0.25 | 0 | 0 | 0 | 0 |
| Octoate | | | | | | |
| Lithium | 0 | 0 | 0.13 | 0 | 0 | 0 |
| Acetate | | | | | | |
| Quaternary | 0 | 0 | 0 | 0.2 | 0 | 0 |
| ammonium | | | | | | |
| formate¹ | | | | | | |
| Zinc acetate | 0 | 0 | 0 | 0 | 0.262 | 0 |
| Blow-off | 78 | 107 | 88 | 123 | 114 | 156 |
| Airflow, | 0.33 | 0.31 | 0.31 | 0.54 | 0.17 | 0.30 |
| ft³/min | | | | | | |
| (L/min) | (9.3) | (8.8) | (8.8) | (15.3) | (4.8) | (8.5) |
| Density, lb/ft³ | 4.70 | 4.56 | 4.23 | 3.86 | 3.86 | 4.13 |
| (kg/m³) | (75.2) | (73.0) | (67.7) | (61.8) | (61.8) | (66.1) |
| Compression | 6 | 5 | 6 | 5 | 5 | 6 |
| Recovery, s | | | | | | |
| Resiliency, % | 14 | 10 | 7 | 8 | 4 | 5 |
| Tear Str., N/m | 200 | 181 | 205 | 189 | 164 | 175 |
| Tensile Str., | 117 | 99 | 94 | 65 | 65 | 57 |
| kPa | | | | | | |
| Elongation, % | 119 | 130 | 151 | 150 | 170 | 132 |

*Not an example of the invention. It contains no e) additive.
¹Hydroxyalkyl trialkyl ammonium formate catalyst sold commercially as Dabco TMR-5 catalyst.

The data in Table 6 shows that good quality, easily processable VE foam can be prepared using a variety of component e) additives.

### EXAMPLES 24 AND 25 AND COMPARATIVE SAMPLE C-8

VE foam example 24 is made in the general manner described with respect to Example 17, using the following formulation:

| | | |
|---|---|---|
| Polyol D | 95 | parts by weight |
| Polyol C | 5 | parts by weight |
| Water | 1.5 | parts by weight |
| Surfactant A | 1.1 | parts by weight |
| Amine Catalyst A | 0.15 | parts by weight |
| Amine Catalyst B | 0.2 | parts by weight |
| Tin Catalyst A | 0.03 | parts by weight |
| Lithium Polyether Salt | 0.87 | parts by weight |
| TDI 80 | to 87 | index |

The lithium polyether salt is prepared by reacting a 3000 molecular weight, nominally three-functional poly(propylene oxide) polyol with an amount of cyclohexane dicarboxylic anhydride sufficient to, on average, convert 2 hydroxyl groups/molecule to carboxylic acid groups. The carboxylic acid groups are then neutralized with lithium hydroxide to form a dilithium salt of the polyether polyol.

VE foam example 25 is made in the same manner, except the amount of the lithium polyether salt is increased to 1.8 parts and the isocyanate index is 92.

Comparative Sample C-8 is made in the same manner as Example 24, omitting the lithium polyether salt, increasing the amount of amine catalyst B to 0.3 parts, and adjusting the isocyanate index to 90.

Foam properties are measured as before and are as reported in Table 7.

TABLE 7

| | Example or Comparative Sample No. | | |
|---|---|---|---|
| | 24 | 25 | C-8* |
| Blow-off | 148 | 128 | 165 |
| Airflow, ft³/min (L/min) | 0.30 (8.5) | 0.42 (11.9) | 0.16 (4.5) |
| Density, lb/ft³ (kg/m³) | 4.16 (66.6) | 3.77 (60.4) | 4.17 (66.8) |
| Compression Recovery, s | 11 | 9¹ | 5¹ |
| Resiliency, % | 5 | 7 | 3 |
| Tear Str., N/m | 164 | 171 | 144 |
| Tensile Str., kPa | 48 | 46 | 41 |
| Elongation, % | 162 | 143 | 111 |

*Not an example of the invention.
¹Compression recovery measurements for these samples are determined using a modification of the ASTM method. A 10 cm × 10 cm sample is compressed with a foot that is larger than the top surface of the sample, and the recovery time is that required for the sample to impose a force of 1 Newton to the withdrawn foot.

### EXAMPLE 26 AND COMPARATIVE SAMPLE C-9*

VE foam example 26 is made in the general manner described with respect to Example 17, using the following formulation:

| | | |
|---|---|---|
| Polyol D | 95 | parts by weight |
| Polyol C | 5 | parts by weight |
| Water | 1.5 | parts by weight |
| Surfactant A | 1.1 | parts by weight |
| Amine Catalyst A | 0.15 | parts by weight |
| Amine Catalyst B | 0.1 | parts by weight |
| Tin Catalyst A | 0.03 | parts by weight |
| Lithium Acetate | 0.16 | parts by weight |
| TDI 65 | to 90 | index |

Comparative Sample C-9 is made in the same manner as Example 26, omitting the lithium acetate and increasing the amount of amine catalyst B to 0.3 parts.

Foam properties are measured as before and are as reported in Table 8.

TABLE 8

Example or Comparative
Sample No.

| | 26 | C-9* |
|---|---|---|
| Blow-off | 75 | 156 |
| Airflow, ft³/min (L/min) | 0.48 (13.6) | 0.47 (13.3) |
| Density, lb/ft³ (kg/m³) | 3.9 (62.4) | 3.5 (56.0) |
| ILD¹ | | |
| 25% | 2.33 | 1.96 |
| 65% | 5.04 | 4.37 |
| 75% | 9.21 | 8.16 |
| Compression Recovery¹, s | 33 | 13 |
| Resiliency, % | 4 | 3 |
| Tear Str., N/m | 195 | 159 |
| Tensile Str., kPa | 70 | 38 |
| Elongation, % | 213 | 157 |

*Not an example of this invention.
¹These values are determined using the modified ASTM procedure described in note 1 to Table 7.

Again, faster blow-off and finer cell structure are seen in the inventive foam.

### EXAMPLES 27-32 AND COMPARATIVE SAMPLE C-10*

VE foam Examples 27-32 and Comparative Sample C-10 are made in the general manner described with respect to Examples 1-4, using the following base formulation:

| Polyol D | 95 | parts by weight |
|---|---|---|
| Polyol C | 5 | parts by weight |
| Water | 1.25 | parts by weight |
| Surfactant A | 1 | part by weight |
| Amine Catalyst A | 0.15 | parts by weight |
| Amine Catalyst B | 0.3 | parts by weight |
| Sodium Acetate Solution | 0.13 | parts by weight |
| Tin Catalyst A | 0.03 | parts by weight |
| Component e | as indicated in Table 9 | |
| TDI 80 | to 90 | index |

TABLE 9

| | Ex. or Comparative Sample No. | | | | | | |
|---|---|---|---|---|---|---|---|
| | C-10* | 27 | 28 | 29 | 30 | 31 | 32 |
| Component e) | None | Li | Na | K | Na | Na | Na |
| type | | Benzoate | Benzoate | Benzoate | Nitro- | Methyl- | Chloro- |
| | | | | | benzoate | benzoate | benzoate |
| Component e) | 0 | 0.107 | 0.12 | 0.133 | 0.139 | 0.127 | 0.131 |
| amount, pbw | | | | | | | |
| Blow-off time, s | 190 | 137 | 128 | 138 | 205 | 133 | 160 |
| Airflow, L/s | 0.54 | 0.31 | 0.49 | 0.34 | 0.72 | 0.60 | 0.67 |
| 90% | 2.5 | 2.3 | 4.7 | 10.6 | 6.2 | 4.8 | 6.6 |
| Compression | | | | | | | |
| Set, % | | | | | | | |
| Density, lb/ft³ | 4.03 | 4.32 | 4.50 | 4.57 | 4.26 | 4.25 | 4.20 |
| (kg/m³) | | | | | | | |
| Resiliency, % | 7 | 5 | 9 | 8 | 8 | 8 | 7 |
| Tear strength, | 150 | 120 | 176 | 152 | 164 | 164 | 160 |
| N/m | | | | | | | |
| Tensile | 53 | 43 | 72 | 74 | 53 | 66 | 60 |
| Strength, kPa | | | | | | | |
| Elongation, % | 135 | 104 | 133 | 125 | 129 | 138 | 138 |

*Not an example of the invention.

What is claimed is:

1. A process for preparing a viscoelastic polyurethane foam having a resiliency of no greater than 20% as measured according to ATSM D-3574-H ball rebound test comprising
A. forming a reaction mixture including at least one base polyol having a functionality of 2.5 to 4 and a molecular weight from 400 to 1100 wherein the base polyol constitutes at least 70% by weight of the reaction mixture, at least one polyisocyanate, water, at least one catalyst and at least one additive, different from the catalyst and different from the polyol(s), selected from
1) alkali metal or transition metal salts of carboxylic acids; and
2) carboxylate salts of quaternary ammonium compounds;
wherein said additive is dissolved in at least one other component of the reaction mixture and
B. subjecting the reaction mixture to conditions sufficient to cause the reaction mixture to expand and cure to form a viscoelastic polyurethane foam.

2. A process for preparing a viscoelastic polyurethane foam having a resiliency of no greater than 20% as measured according to ATSM D-3574-H ball rebound test, comprising subjecting a reaction mixture to conditions sufficient for the reaction mixture to expand and cure, wherein the reaction mixture comprises:
a) at least one base polyol having a hydroxyl functionality from about 2.5 to 4 and a molecular weight of from 400 to 1100, or a mixture containing at least 50% by weight of said at least one base polyol and at least one other monoalcohol or polyol different from component e) having a hydroxyl equivalent weight of at least 125;
b) at least one organic polyisocyanate;
c) from 0.8 to about 2.25 parts by weight of water per 100 parts by weight of component a);
d) at least one catalyst different than component e); and
e) an amount of an additive sufficient to reduce the blow-off time of the reaction mixture, wherein the additive is selected from
1) alkali metal or transition metal salts of carboxylic acids; and
2) carboxylate salts of quaternary ammonium compounds,
wherein said additive is dissolved in at least one other component of the reaction mixture and the isocyanate index is from 85 to 110.

3. The process of claim 2 which is a slabstock process.

4. The process of claim 3 wherein the additive includes a lithium, sodium, potassium, cesium, zinc, copper, nickel or silver salt of a C₂₋₁₈ monocarboxylic acid.

5. The process of claim 4 wherein the additive is present in an amount from about 0.01 to 1.0 part per 100 parts by weight of component a).

6. The process of claim 5 wherein the polyisocyanate is a blend of TDI isomers containing at least 80% by weight of the 2,4-isomer.

7. The process of claim 6 wherein the viscoelastic foam has a density of from 3 to 8 pounds/cubic foot (48-128 kg/m3).

8. The process of claim 7 wherein the reaction mixture contains from 0.8 to 1.3 parts of water per 100 parts by weight of component a).

9. The process of claim 8 wherein the viscoelastic foam has a density of from 3.5 to 6 pounds/cubic foot (56-96 kg/m³) and the viscoelastic foam exhibits a resiliency of no greater than 10% as measured according to the ATSM D-3574-H ball rebound test.

10. The process of claim 3 wherein the additive includes a quaternary ammonium salt of a C₁₋₁₂ carboxylic acid.

11. The process of claim 10 wherein the additive includes a hydroxyalkyltrialkykammonium salt of a C₁₋₁₂ carboxylic acid.

12. The process of claim 11 wherein the additive is present in an amount from about 0.01 to 1.0 part per 100 parts by weight of component a).

13. The process of claim 12 wherein the polyisocyanate is a blend of TDI isomers containing at least 80% by weight of the 2,4-isomer.

14. The process of claim 13 wherein the reaction mixture contains from 0.8 to 1.3 parts of water per 100 parts by weight of component a).

15. The process of claim 14 wherein the viscoelastic foam has a density of from 3.5 to 6 pounds/cubic foot (56-96 kg/m³) and the viscoelastic foam exhibits a resiliency of no greater than 10% as measured according to the ATSM D-3574-H ball rebound test.

16. The process of claim 3, wherein the additive includes an alkali metal or quaternary ammonium salt of a carboxyl-containing organic polymer present in an amount of from about 1 to about 25 parts per 100 parts by weight of component a).

17. The process of claim 16, wherein the carboxyl-containing organic polymer has an equivalent weight per carboxyl group of from 150 to 5000.

18. The process of claim 17, wherein the carboxyl-containing organic polymer is a polyether polyol having a carboxyl equivalent weight of from 500 to 3000 and a carboxyl functionality of from 1 to 4.

19. A formulated polyol composition comprising at least one base polyol having a hydroxyl functionality from about 2.5 to 4 and a molecular weight of from 400 to 1500, or a mixture containing at least 50% by weight of said at least one base polyol and at least one other monoalcohol or polyol having a hydroxyl equivalent weight of at least 200; and
an additive different from said at least one other monoalcohol or polyol and selected from
1) alkali metal or transition metal salts of carboxylic acids; and
2) carboxylate salts of quaternary ammonium compounds wherein said additive is dissolved in said formulated polyol composition.
